(19) United States
(12) Patent Application Publication
(10) Pub. No.: US 2026/0299992 A1
(43) Pub. Date: Oct. 1, 2026

(54) LIVE MIGRATION METHOD FOR VIRTUAL MACHINE, DEVICE AND STORAGE MEDIUM

(71) Applicant: CLOUD INTELLIGENCE ASSETS HOLDING (SINGAPORE) PRIVATE LIMITED, Singapore (SG)

(72) Inventor: Bing HU, Shanghai (CN)

(73) Assignee: CLOUD INTELLIGENCE ASSETS HOLDING (SINGAPORE) PRIVATE LIMITED, Singapore (SG)

(21) Appl. No.: 19/480,357

(22) PCT Filed: Apr. 18, 2024
(86) PCT No.: PCT/CN2024/088675

§ 371 Date: Oct. 30, 2025

(30) Foreign Application Priority Data
May 22, 2023 (CN) 202310581692.2

(51) Int. Cl. G06F 9/455

(52) U.S. Cl. CPC G06F 9/45558; G06F 2009/4557

(57) ABSTRACT

A live migration method for a virtual machine, a computing device, and a storage medium are provided. The live migration method is applied to a cloud computing system including a plurality of physical nodes, and a plurality of virtual machines are run on at least some of the plurality of physical nodes. The method includes: determining at least one virtual machine to be migrated from among the plurality of virtual machines based on status information of each of the plurality of virtual machines; predicting a live migration result for each of the at least one virtual machine to be migrated, and determining a target physical node corresponding to a target virtual machine from among the plurality of physical nodes based on the predicted live migration result, the target virtual machine being the virtual machine to be migrated; and live-migrating the target virtual machine to the target physical node.

### CROSS REFERENCE TO RELATED APPLICATIONS

This application is a National Stage of International Application PCT/CN2024/088675, filed on Apr. 18, 2024, which claims priority to Chinese Patent Application No. 202310581692.2, filed with the China National Intellectual Property Administration on May 22, 2023 and entitled “HOT MIGRATION METHOD FOR VIRTUAL MACHINE AND RELATED DEVICE”, the mentioned applications are incorporated herein by reference in their entirety.

### TECHNICAL FIELD

One or more embodiments of this specification relate to the field of cloud computing technologies, and in particular, to a live migration method for a virtual machine, a device and a storage medium.

### BACKGROUND

In a cloud computing system, a physical node may be overloaded by running a plurality of virtual machines, thereby affecting the performance of each virtual machine. Based on this, a virtual machine may be migrated from a current physical node to another physical node using a live migration (Hot Migration) method without shutting down or suspending the virtual machine, to seamlessly and losslessly adjust resource allocation and load balancing in a cloud computing system, thereby ensuring the performance of each virtual machine.

However, during live migration, a virtual machine is readily prone to migration timeout or migration failure, which further affects the security and stability of a cloud computing system. Therefore, how to accurately select a virtual machine that requires live migration and a target physical node to implement effective and reliable live migration is a problem to be urgently resolved.

### SUMMARY

In view of this, one or more embodiments of this specification provide a live migration method for a virtual machine and a related device.

According to a first aspect, this specification provides a live migration method for a virtual machine, applied to a cloud computing system, the cloud computing system including a plurality of physical nodes, and a plurality of virtual machines running on at least some of the plurality of physical nodes; the method including: determining at least one virtual machine to be migrated from among the plurality of virtual machines based on status information of the plurality of virtual machines; predicting a live migration result for the at least one virtual machine to be migrated, and determining a target physical node corresponding to a target virtual machine from among the plurality of physical nodes based on the predicted live migration result, the target virtual machine being the virtual machine to be migrated; and live-migrating the target virtual machine to the target physical node.

According to a second aspect, this specification provides a live migration apparatus for a virtual machine, applied to a cloud computing system, the cloud computing system including a plurality of physical nodes, and a plurality of virtual machines running on at least some of the plurality of physical nodes; the apparatus including: a determining unit, configured to determine at least one virtual machine to be migrated from among the plurality of virtual machines based on status information of the plurality of virtual machines; a prediction unit, configured to: predict a live migration result for the at least one virtual machine to be migrated, and determine a target physical node corresponding to a target virtual machine from among the plurality of physical nodes based on the predicted live migration result, the target virtual machine being the virtual machine to be migrated; and a live migration unit, configured to live-migrate the target virtual machine to the target physical node.

Correspondingly, this specification further provides a computing device, including a memory and a processor, the memory having a computer program executable on the processor stored therein; the processor, when executing the computer program, performing the live migration method for a virtual machine in the foregoing implementations.

Correspondingly, this specification further provides a computer-readable storage medium, having a computer program stored therein, and the computer program, when executed by a processor, implementing the live migration method for a virtual machine in the foregoing implementations.

### BRIEF DESCRIPTION OF DRAWINGS

FIG. 1 is a schematic architectural diagram of a cloud computing system according to an exemplary embodiment;

FIG. 2 is a schematic flowchart of a live migration method for a virtual machine according to an exemplary embodiment;

FIG. 3 is a schematic structural diagram of a live migration system according to an exemplary embodiment;

FIG. 4 is a schematic structural diagram of a live migration apparatus for a virtual machine according to an exemplary embodiment; and

FIG. 5 is a schematic structural diagram of a server according to an exemplary embodiment.

### DETAILED DESCRIPTION

The exemplary embodiments are described in detail herein, and the examples of the embodiments are represented in the accompanying drawings. In the following description regarding the accompanying drawings, unless otherwise indicated, the same reference numerals in different accompanying drawings represent the same or similar elements. Implementations described in the following example embodiments do not represent all implementations consistent with one or more embodiments of this specification. On the contrary, the implementations are merely examples of apparatuses and methods that are described in the appended claims in detail and that are consistent with some aspects of one or more embodiments of this specification.

It should be noted that in other embodiments, steps of a corresponding method are not necessarily performed in an order shown and described in this specification. In some other embodiments, the method may include more or fewer steps than those described in this specification. In addition, a single step described in this specification may be decomposed into a plurality of steps for description in other embodiments, and a plurality of steps described in this specification may be combined into a single step for description in another embodiment.

All user information (including, but not limited to, user equipment information, and user personal information) and data (including, but not limited to, data for analysis, stored data, and displayed data) in the present application are information and data that are authorized by users or fully authorized by all parties. The collection, use, and processing of related data must comply with applicable laws, regulations, and standards in relevant countries and regions, and corresponding operational entries are provided for users to choose whether to grant or deny authorization.

Some terms in this specification are first described to help persons skilled in the art have a better understanding.

(1) Cloud computing is an Internet-based computing mode, and abstracts, by using a virtualization technology, a physical resource (for example, a central processing unit (Central Processing Unit, CPU), memory, storage, and a network) into a virtual resource (for example, a virtual machine, a virtual network, and virtual storage) that can be allocated and used on demand. Cloud computing has advantages such as flexibility, scalability, low costs, and high efficiency, and is widely applied to various industries and fields.

(2) A physical node (or referred to as a physical machine) is a hardware device (provided with physical resources such as a CPU, memory, and a hard disk) in a cloud computing system. The physical node provides a hardware condition for running of a virtual machine (Virtual Machine), and one or more virtual machines may run on each physical node. When a virtual machine is created in a physical node, a part of memory and hard disk capacity in the physical node need to be used as hard disk and memory capacity of the virtual machine. Each virtual machine running on the physical node may also be referred to as a virtual machine instance (Instance).

(3) Live migration (Hot Migration) is a process of migrating a virtual machine instance from one physical node to another physical node without closing or suspending a virtual machine instance. The live migration can implement a seamless and lossless adjustment of resource allocation and load balancing in a cloud computing system. However, live migration also has some risks, for example, a migration timeout, a migration failure, and data loss.

Correspondingly, cold migration (Cold Migration) is a process of migrating a virtual machine instance from one physical node to another physical node after the virtual machine instance is closed or suspended. Details are not described herein again.

(4) An instance performance profile (Instance Performance Profile) is data or a model that describes and measures a status and performance of a virtual machine instance. The instance performance profile of the virtual machine may include data in various aspects, for example, including CPU usage, memory usage, disk usage, network bandwidth, latency, and throughput corresponding to the virtual machine. This is not specifically limited in this specification. The instance performance profile of the virtual machine may be used to evaluate quality and a requirement of a virtual machine instance and provide a reference basis for live migration.

(5) Ensemble learning (ensemble learning) is constructing and combining a plurality of machine learning models to complete a learning task. In a supervised learning algorithm of machine learning, an objective is to learn a stable model that performs well in various aspects, but an actual situation is usually not ideal, and usually, only a plurality of models with biases (that is, a plurality of weakly supervised models, and each weakly supervised model may perform well in some aspects) can be obtained. The ensemble learning may combine a plurality of weakly supervised models to obtain a better and more comprehensive strongly supervised model (or referred to as an ensemble model).

As described above, in a cloud computing system, a physical node may be overloaded by running a plurality of virtual machines, and the plurality of virtual machines may contend for resources (for example, resources such as a CPU and memory) on the physical node. Consequently, the performance of each virtual machine running on the node is reduced, and further, data loss or service interruption of a user is caused, causing serious loss to the user. Based on this, a virtual machine may be migrated from a current physical node to another physical node using a live migration method without shutting down or suspending the virtual machine, to seamlessly and losslessly adjust resource allocation and load balancing in a cloud computing system, thereby ensuring the performance of each virtual machine.

However, during live migration, a virtual machine is prone to migration timeout, migration failure, or data loss, which further affects the security and stability of a cloud computing system, resulting in degraded cloud services. Therefore, how to accurately select a virtual machine that requires live migration and a target physical node to implement effective and reliable live migration is a problem to be urgently resolved.

Based on this, this specification provides a technical solution of selecting, based on status information of a plurality of virtual machines, at least one virtual machine that requires live migration, and then selecting, based on a live migration prediction result of each virtual machine to be migrated, an appropriate target physical node for each virtual machine to be migrated to perform live migration, thereby implementing effective and reliable live migration.

During implementation, in the present application, status information of a plurality of virtual machines running on a physical node in a cloud computing system may be obtained, and at least one virtual machine to be migrated is determined from among the plurality of virtual machines based on the status information. Then, a live migration result is predicted for the at least one virtual machine to be migrated, and a target physical node corresponding to any target virtual machine in the at least one virtual machine to be migrated is determined from among the plurality of physical nodes in the cloud computing system based on the predicted live migration result. Further, the target virtual machine is live-migrated to the target physical node.

In the foregoing technical solution, in a cloud computing system including a plurality of physical nodes, in the present application, status information of each virtual machine running on at least some of the plurality of physical nodes may be first obtained. Then, in the present application, at least one virtual machine that requires live migration may be determined from among all the virtual machines based on the status information of each virtual machine. For the virtual machine to be migrated, a live migration result of the virtual machine may be predicted first, and then an appropriate target physical node is selected for the virtual machine to be migrated based on the predicted live migration result, and is live-migrated to the target physical node. In this way, in the present application, a virtual machine that requires live migration is selected based on status information of the virtual machine, and an appropriate target physical node is further selected for the virtual machine based on a live migration prediction result of the virtual machine to perform live migration, to greatly improve the reliability of live migration and reduce risks such as a live migration failure and a live migration timeout, thereby ensuring the security and reliability of an entire cloud computing system, and providing a cloud service with higher quality and higher stability to a user.

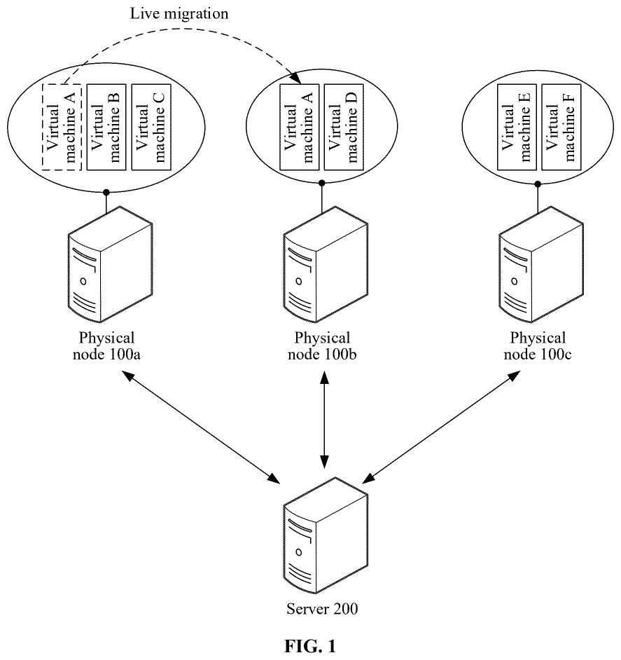

FIG. 1 is a schematic architectural diagram of a cloud computing system according to an exemplary embodiment. As shown in FIG. 1, the cloud computing system may include a plurality of physical nodes, for example, a physical node 100a, a physical node 100b, and a physical node 100c. In an illustrated implementation, the physical node 100a, the physical node 100b, and the physical node 100c may communicate with each other through a network connection. As shown in FIG. 1, the cloud computing system may further include a server 200. In an illustrated implementation, the server 200 may establish a communication connection to the physical node 100a, the physical node 100b, and the physical node 100c. For example, the server 200 may communicate with the physical node 100a, the physical node 100b, and the physical node 100c through a network connection.

In an illustrated implementation, one or more virtual machines may run on the physical node 100a, the physical node 100b, and the physical node 100c.

For example, as shown in FIG. 1, a virtual machine A, a virtual machine B, and a virtual machine C run on the physical node 100a, a virtual machine D runs on the physical node 100b, and a virtual machine E and a virtual machine F run on the physical node 100c.

In an illustrated implementation, the server 200 may detect a status and performance of each physical node in real time, and may further obtain status information of each virtual machine running on each physical node. For example, the server 200 may obtain the status information of the virtual machine A, the virtual machine B, and the virtual machine C running on the physical node 100a, obtain the status information of the virtual machine D running on the physical node 100b, obtain the status information of the virtual machine E and the virtual machine F running on the physical node 100c, and the like.

In an illustrated implementation, the status information of the virtual machine may include CPU usage, memory usage, disk usage, network bandwidth, network latency, throughput, and the like of the virtual machine. This is not specifically limited in this specification.

In an illustrated implementation, the server 200 may determine at least one virtual machine to be migrated from among all the virtual machines based on the obtained status information of each virtual machine.

In an illustrated implementation, the server 200 may predict a live migration performance degradation rate of each virtual machine based on the obtained status information of each virtual machine. The live migration performance degradation rate may indicate a degree of performance loss incurred by the virtual machine during live migration.

For example, if the live migration performance degradation rate is 50%, it may indicate that half of the performance of the virtual machine is going to be lost after live migration, that is, the performance of the virtual machine after live migration is half of the performance of the virtual machine before live migration. For another example, if the live migration performance degradation rate is 20%, it may indicate that 20% of the performance of the virtual machine is going to be lost after live migration, that is, the performance of the virtual machine after live migration is 80% of the performance of the virtual machine before live migration. Examples are not enumerated herein again.

In an illustrated implementation, the server 200 may determine, based on the predicted live migration performance degradation rate of each virtual machine, a virtual machine whose live migration performance degradation rate is less than a performance degradation rate threshold as the virtual machine to be migrated.

In an illustrated implementation, the performance degradation rate threshold may be used for representing the severest performance loss that a user or a system can accept. In an illustrated implementation, the performance degradation rate threshold may be set according to a user requirement or an actual situation. For example, the performance degradation rate threshold may be 50%, 45%, 20%, or the like. This is not specifically limited in this specification.

For example, if a user has a high requirement on cloud service quality (that is, the user has low tolerance for virtual machine performance degradation), the performance degradation rate threshold may be set to a low value (for example, 10%), to ensure the performance of each virtual machine on which live migration is performed. If a user is more concerned about resource utilization in a cloud computing system (that is, the user has high tolerance for virtual machine performance degradation), the performance degradation rate threshold may be set to a high value (for example, 60%), so that more virtual machines can be live-migrated, and the like. This is not specifically limited in this specification.

For example, an example in which the performance degradation rate threshold is 20% is used. The server 200 predicts, based on the obtained status information of each virtual machine, that the live migration performance degradation rate of the virtual machine A is 10%, the live migration performance degradation rate of the virtual machine B is 40%, the live migration performance degradation rate of the virtual machine C is 30%, the live migration performance degradation rate of the virtual machine D is 30%, the live migration performance degradation rate of the virtual machine E is 25%, and the live migration performance degradation rate of the virtual machine F is 60%, so that the server 200 may determine the virtual machine A whose live migration performance degradation rate is less than the performance degradation rate threshold as the virtual machine to be migrated.

In an illustrated implementation, after determining the at least one virtual machine to be migrated, the server 200 may predict a live migration result for the at least one virtual machine to be migrated, and select an appropriate target physical node for each virtual machine based on the predicted live migration result to perform live migration.

For example, the appropriate target physical node may be a physical node with idle computing resources. For example, no virtual machine runs or only a very small number of virtual machines run on the target physical node. This is not specifically limited in this specification.

In an illustrated implementation, the server 200 may predict the live migration result for the at least one virtual machine to be migrated based on a current resource occupation status and a subsequent resource occupation change of the at least one virtual machine to be migrated.

In an illustrated implementation, the predicted live migration result may include a live migration timeout probability of the virtual machine. The live migration timeout probability may indicate a probability that live migration duration required by the virtual machine during live migration exceeds a duration threshold. The duration threshold may be live migration duration that is preset according to a user requirement or an actual situation of the cloud computing system. For example, if the virtual machine does not complete live migration within the duration threshold, it is highly likely that the virtual machine fails to be migrated, or the current live migration is directly determined as a migration failure. This is not specifically limited in this specification.

For example, the live migration timeout probability is 100%, which may indicate that live migration of a virtual machine definitely times out or is highly likely to time out, leading to a migration failure. For another example, if the live migration timeout probability is 10%, it may indicate that the live migration of the virtual machine basically does not time out, and the success rate of the live migration is high, and the like. Examples are not enumerated herein again.

In an illustrated implementation, when different target physical nodes are selected for the virtual machine to be migrated to perform live migration, due to differences between the status and performances of the different target physical nodes (for example, differences in a quantity of CPU cores, a size of memory capacity, and a quantity of running virtual machines) and differences in quality of network connections between the different target physical nodes and a source physical node (that is, a physical node on which the virtual machine to be migrated is currently located), live migration effects of a same virtual machine corresponding to the different target physical nodes may also be different. For example, the live migration effect may include, for example, a live migration timeout probability in the foregoing live migration result, and may further include a probability that the virtual machine is faulty on the target physical node after live migration is completed, a probability that performance is further degraded, and the like. Based on this, the server 200 may select, based on the current resource occupation status and the subsequent resource occupation change of the at least one virtual machine to be migrated and further with reference to the status and performance of each physical node, quality of network connections between the physical nodes, and the like, an appropriate target physical node for the virtual machine to be migrated to perform live migration.

For example, as shown in FIG. 1, the server 200 may predict a live migration result of the virtual machine A to be migrated, select the physical node 100b as the target physical node based on the predicted live migration result, and live-migrate the virtual machine A to the physical node 100b.

In an illustrated implementation, the physical node 100a, the physical node 100b, and the physical node 100c may be one server or a server cluster including a plurality of servers that has the foregoing functions.

In an illustrated implementation, the server 200 may be one server or a server cluster including a plurality of servers that has the foregoing functions. For example, if the server 200 is a server cluster including a plurality of servers, different functions of the server 200 may be implemented by different servers in the server cluster. For example, the obtaining of status information of a virtual machine, the prediction of a live migration result before live migration, and actual live migration processing may be implemented by different servers in the server cluster. This is not specifically limited in this specification.

In an illustrated implementation, the server 200 may alternatively be any one of the physical node 100a, the physical node 100b, and the physical node 100c, or the server 200 may include a plurality of physical nodes of the physical node 100a, the physical node 100b, and the physical node 100c. That is, the functions related to the foregoing live migration method may be implemented by using a physical node of the cloud computing system, and the like. This is not specifically limited in this specification.

In an illustrated implementation, the server 200 may alternatively be a server or a server cluster that is independent of a cloud computing system and is connected to each physical node in the cloud computing system. This is not specifically limited in this specification.

In an illustrated implementation, the server 200 may alternatively be a performance degradation awareness system in a cloud environment (Performance Degrade in Cloud Environment). The performance degradation awareness system may detect and predict, in a cloud computing environment, a fault or an attack to which a virtual machine instance is vulnerable, and take corresponding measures in time, thereby ensuring that availability and security of a cloud service. In an illustrated implementation, the live migration method for a virtual machine provided in the present application may be applied to the performance degradation awareness system, to assist in the reliable and effective live migration of a virtual machine in the cloud computing system, thereby minimizing faults on the virtual machine.

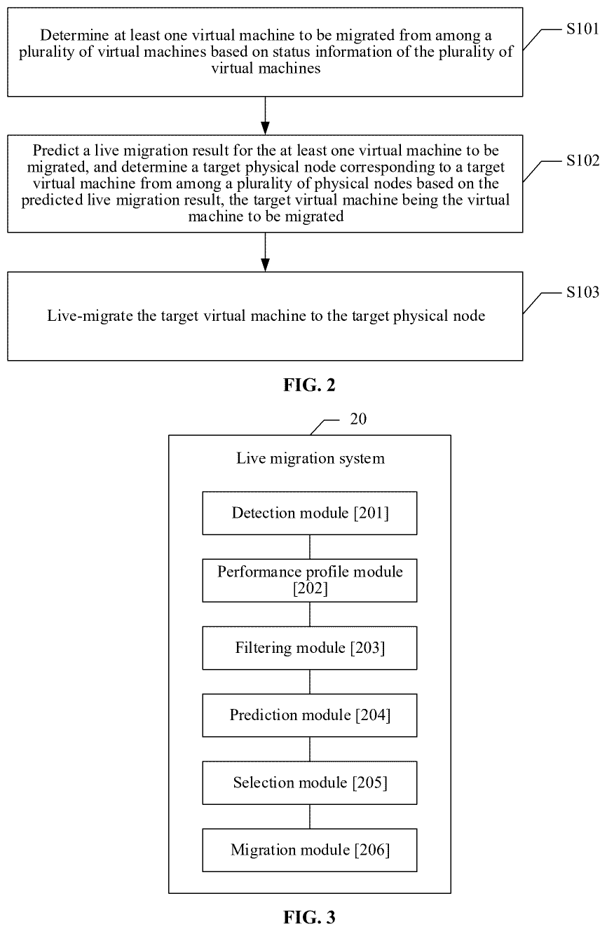

FIG. 2 is a schematic flowchart of a live migration method for a virtual machine according to an exemplary embodiment. The method may be applied to a cloud computing system. For example, the method may be specifically applied to the server 200 shown in FIG. 1. The server 200 may be one server, a server cluster including plurality of servers, or the like. This is not specifically limited in this specification. As shown in FIG. 2, the method may specifically include the following Steps S101 to step S103.

Step S101. Determine at least one virtual machine to be migrated from among the plurality of virtual machines based on status information of the plurality of virtual machines.

In an illustrated implementation, the cloud computing system includes a plurality of physical nodes, and a plurality of virtual machines may run on at least some of the plurality of physical nodes.

For example, each virtual machine may be configured with one or more virtual CPUs (vCPU). Details are not described herein again.

In an illustrated implementation, in a process of running the virtual machines, in the present application, a status and performance of each physical node may be detected in real time, and a status and performance of each virtual machine running on each physical node may be detected in real time, to further obtain the status information of the plurality of virtual machines.

In an illustrated implementation, the status information of the virtual machine may include CPU usage, memory usage, disk usage, network bandwidth, network latency, throughput, and the like of the virtual machine. This is not specifically limited in this specification. In some possible implementations, the status information of the virtual machine may further include any other possible information used for describing the status of the virtual machine. This is not specifically limited in this specification.

In an illustrated implementation, in the present application, at least one virtual machine to be migrated may be determined from among the plurality of virtual machines based on the obtained status information of the plurality of virtual machines.

In an illustrated implementation, in the present application, the live migration performance degradation rates of the plurality of virtual machines may be predicted based on the obtained status information of the plurality of virtual machines, and at least one virtual machine to be migrated may be determined from among the plurality of virtual machines based on the live migration performance degradation rates of the plurality of virtual machines.

The live migration performance degradation rate may indicate a degree of performance loss incurred by the virtual machine during live migration. For example, if the live migration performance degradation rate is 50%, it may indicate that half of the performance of the virtual machine is going to be lost after live migration, that is, the performance of the virtual machine after live migration is half of the performance of the virtual machine before live migration. For another example, if the live migration performance degradation rate is 10%, it may indicate that 10% of the performance of the virtual machine is going to be lost after live migration, that is, the performance of the virtual machine after live migration is 90% of the performance of the virtual machine before live migration. Examples are not enumerated herein again.

For example, higher CPU usage of the virtual machine may indicate and higher live migration performance degradation rate of the virtual machine, higher memory usage of the virtual machine may also indicate a higher live migration performance degradation rate of the virtual machine, and severer network latency of the virtual machine may also indicate a higher live migration performance degradation rate of the virtual machine. This is not specifically limited in this specification.

In an illustrated implementation, in the present application, in the process of determining at least one virtual machine to be migrated from among the plurality of virtual machines based on the live migration performance degradation rates of the plurality of virtual machines, specifically, a virtual machine whose live migration performance degradation rate is less than a performance degradation rate threshold in the plurality of virtual machines may be determined as the virtual machine to be migrated, to select the at least one virtual machine to be migrated from among the plurality of virtual machines.

In an illustrated implementation, the performance degradation rate threshold may be set according to a user requirement or an actual situation. This is not specifically limited in this specification. For example, the performance degradation rate threshold may be 50%, 45%, 20%, or the like. This is not specifically limited in this specification.

For example, if a user has a high requirement on cloud service quality (that is, the user has low tolerance for virtual machine performance degradation), the performance degradation rate threshold may be set to a low value (for example, 5%), to ensure the performance of each virtual machine on which live migration is performed. If a user is more concerned about resource utilization in a cloud computing system (that is, the user has high tolerance for virtual machine performance degradation), the performance degradation rate threshold may be set to a high value (for example, 60%), so that more virtual machines can be live-migrated, and the like. This is not specifically limited in this specification.

In an illustrated implementation, the status information of the virtual machine may include an instance performance profile of the virtual machine.

In an illustrated implementation, in the present application, the instance performance profile of each virtual machine may be obtained based on each piece of detected status and performance data of the virtual machine during running. In an illustrated implementation, the instance performance profile of the virtual machine may include data or a model used for describing the status of the virtual machine, for example, the foregoing CPU usage, memory usage, disk usage, network bandwidth, network latency, and throughput.

In an illustrated implementation, in the present application, a performance degradation label and a migration eligibility label corresponding to each virtual machine may be further generated based on the instance performance profile of each virtual machine. For example, in the present application, the live migration performance degradation rate of each virtual machine may be predicted based on the instance performance profile of each virtual machine, and the performance degradation label and the migration eligibility label corresponding to each virtual machine may be generated based on the live migration performance degradation rate of each virtual machine. The performance degradation label may indicate a live migration performance degradation rate of the virtual machine, and the migration eligibility label may indicate that the virtual machine can be live-migrated. In an illustrated implementation, when the live migration performance degradation rate of a virtual machine is less than the performance degradation rate threshold, the virtual machine may have a corresponding migration eligibility label.

In an illustrated implementation, in the present application, a virtual machine having a migration eligibility label (that is, a virtual machine whose live migration performance degradation rate is less than the performance degradation rate threshold) may be determined as the virtual machine to be migrated based on the performance degradation label and the migration eligibility label that correspond to each virtual machine. This is not specifically limited in this specification.

Step S102. Predict a live migration result for the at least one virtual machine to be migrated, and determine a target physical node corresponding to a target virtual machine from among the plurality of physical nodes based on the predicted live migration result, the target virtual machine being the virtual machine to be migrated.

In an illustrated implementation, after the at least one virtual machine to be migrated is determined from among the plurality of virtual machines, in the present application, the live migration result may be predicted for the at least one virtual machine to be migrated, and the target physical node corresponding to any target virtual machine in the at least one virtual machine to be migrated may be determined from among the plurality of physical nodes included in the cloud computing system based on the predicted live migration result. Subsequently, the target virtual machine may be live-migrated from a source physical node in which the target virtual machine is located to the target physical node corresponding to the target virtual machine.

In an illustrated implementation, in the present application, the live migration result for the at least one virtual machine to be migrated may be predicted based on the current resource occupation status and the subsequent resource occupation change of the at least one virtual machine to be migrated. For example, the resource occupation change may include a resource occupation status of the virtual machine within a future period of time.

For example, the resource occupation status of the virtual machine may include an occupation status of resources such as a CPU, memory, and a network, collected for the physical node by the virtual machine. This is not specifically limited in this specification.

In an illustrated implementation, in the present application, a historical resource occupation status of at least one virtual machine to be migrated may be first obtained, and a resource occupation status of the at least one virtual machine to be migrated is predicted based on the historical resource occupation status.

In an illustrated implementation, in the present application, the predicting the resource occupation status of the at least one virtual machine to be migrated may specifically include predicting a resource occupation status of the at least one virtual machine to be migrated within preset duration after a current moment. For example, the preset duration may be set according to a user requirement or an actual situation, and is, for example, 10 minutes, 5 minutes, or 20 minutes. This is not specifically limited in this specification.

For example, the historical resource occupation status may be all historical resource occupation statuses before a current moment after the virtual machine is created, or the historical resource occupation status may alternatively be a historical resource occupation status of the virtual machine within a period of time (for example, 10 minutes or 15 minutes) before the current moment. This is not specifically limited in this specification.

In an illustrated implementation, in the present application, the live migration result for the at least one virtual machine to be migrated may be predicted based on the current resource occupation status of the at least one virtual machine to be migrated and a predicted resource occupation status of the at least one virtual machine to be migrated within the preset duration after the current moment.

In an illustrated implementation, the predicted live migration result may include a live migration timeout probability of the virtual machine. The live migration timeout probability may indicate a probability that live migration duration required by the virtual machine during live migration exceeds a duration threshold. The duration threshold may be preset live migration duration. If the virtual machine does not complete live migration within the duration threshold, it is highly likely that the virtual machine fails to be migrated, or the current live migration may be directly determined as a migration failure. This is not specifically limited in this specification.

For example, the live migration timeout probability is 0%, which may indicate that a probability of live migration timeout is nearly 0. For another example, the live migration timeout probability is 100%, which may indicate that live migration of a virtual machine definitely times out or is highly likely to time out, leading to a migration failure. For another example, if the live migration timeout probability is 10%, it may indicate that the live migration of the virtual machine basically does not time out, and the success rate of the live migration is high, and the like. Examples are not enumerated herein again.

In an illustrated implementation, in the present application, an appropriate target physical node may be further selected for the virtual machine to be migrated based on the foregoing live migration result obtained through prediction and further with reference to a status and performance of each physical node, quality of network connections between the physical nodes, and the like. For details, refer to the descriptions in the embodiment corresponding to FIG. 1, and details are not described herein again.

In an illustrated implementation, in the present application, a live migration result of the at least one virtual machine to be migrated may be predicted based on a prediction model obtained through pre-training.

In an illustrated implementation, in the present application, the current resource occupation status of the virtual machine to be migrated and the predicted resource occupation status of the virtual machine to be migrated within the preset duration after the current moment may be input to the prediction model obtained through pre-training, to predict the live migration result of the virtual machine to be migrated.

It should be noted that this specification does not specifically limit a training method and a model type of the prediction model.

In an illustrated implementation, the prediction model may be an ensemble model that is obtained through training based on an ensemble learning algorithm and in which at least two machine learning models used for predicting a live migration result are ensembled. Correspondingly, in the present application, when live migration result prediction is performed using the ensemble model, live migration timeout probabilities respectively output by the at least two machine learning models in the ensemble model may be combined to further obtain a more accurate live migration timeout probability, thereby providing reliable data support for subsequent implementation of live migration.

In an illustrated implementation, the at least two machine learning models may be basic models, for example, including a decision tree, a support vector machine, and a neural network. This is not specifically limited in this specification.

In an illustrated implementation, in the present application, before the live migration result of each virtual machine is predicted, the at least one virtual machine to be migrated may be sorted first.

In an implementation, in the present application, live migration results of virtual machines in the at least one virtual machine to be migrated may be predicted sequentially according to an order obtained through the sorting, and an appropriate target physical node is selected for the virtual machines sequentially.

In an illustrated implementation, in the present application, alternatively, live migration results of some virtual machines that rank high in the at least one virtual machine may be predicted sequentially according to an order after the sorting, and an appropriate target physical node is selected sequentially for each virtual machine in the some virtual machines. Correspondingly, the target virtual machine to be migrated may be any virtual machine in the some virtual machines.

For example, the some virtual machines may be a preset proportion of virtual machines that rank high in the at least one virtual machine, for example, the first 50% of virtual machines, for another example, the first 60% of virtual machines in the at least one virtual machine. This is not specifically limited in this specification. For example, the some virtual machines may alternatively be a preset quantity of virtual machines that rank high in the at least one virtual machine, for example, the first 10 virtual machines, for another example, the first 8 virtual machines in the at least one virtual machine. This is not specifically limited in this specification.

In an illustrated implementation, in the present application, the at least one virtual machine to be migrated may be sorted based on the preset sorting reference factor.

In an illustrated implementation, the preset sorting reference factor includes one or more of the following factors, or a combination thereof: a current resource occupation status of the virtual machine, a resource occupation status of the virtual machine within the preset duration after the current moment, sensitivity of the virtual machine to a running environment change, a live migration performance degradation rate of the virtual machine, a user performance degradation preference corresponding to the virtual machine, a performance degradation rate threshold corresponding to the virtual machine, a user quota corresponding to the virtual machine, total running duration of the virtual machine, and the like. This is not specifically limited in this specification.

The sensitivity of the virtual machine to a running environment change may affect the feasibility and user experience of performing live migration on the virtual machine. Generally, a virtual machine having low sensitivity to a running environment change exhibits higher adaptability to migration, whereas a virtual machine having high sensitivity exhibits reduced adaptability to migration, has higher performance loss after migration, and has a higher probability of fault. The running environment change may mainly include a difference between running environments of the virtual machine on the source physical node and the target physical node before and after live migration.

The user performance degradation preference may be a tolerance and preference of the user for a function or performance loss that may occur during live migration of the virtual machine. The user performance degradation preference reflects the level of importance that the user places on service quality and a trade-off manner for service quality. Generally, a user with low tolerance for the performance loss of the virtual machine is more concerned about service quality, and the preset performance degradation rate threshold is correspondingly low. A user with high tolerance for the performance loss of the virtual machine is more concerned about resource utilization, and the preset performance degradation rate threshold is also correspondingly high.

A user quota (User quota) corresponding to a virtual machine may be used to measure a total quantity of virtual machine instances operated and maintained by a user in different windows (for example, within one hour, 24 hours, 30 days, or 90 days), and a quantity of virtual machine instances suffers from performance degradation.

The total running duration of a virtual machine may be duration from creation to destruction of the virtual machine (that is, a survival time of the virtual machine). The total running duration of the virtual machine reflects the life cycle and running characteristics of the virtual machine, and also affects the migration necessity and urgency of the virtual machine. Generally, the live migration of a virtual machine with a short total running duration (for example, a newly-created virtual machine) has small impact on a user, and the live migration of a virtual machine with a long total running duration has great impact on a user.

In an illustrated implementation, a priority sorting algorithm may alternatively be designed, and a weight value is assigned to each factor based on the importance and the impact degree of each factor for live migration. A total score for each virtual machine to be migrated is then calculated based on the score of each virtual machine to be migrated in each factor and the weight values of the factors. For example, if the virtual machine is less sensitive to an operation and maintenance environment, the score in the factor is higher; if the virtual machine has shorter total running duration, the score in the factor is higher; if the virtual machine has a smaller live migration performance degradation rate, the score in the factor is higher; and the like. Examples are not enumerated herein again. Finally, the virtual machines to be migrated may be sorted in descending order of total scores. It may be understood that a virtual machine with a higher total score usually has a higher success rate of live migration, and is more appropriate for performing live migration.

In this way, in the present application, the at least one virtual machine to be migrated is sorted, so that live migration result prediction may be preferentially performed and live migration may be implemented for a virtual machine that has a higher success rate of live migration and that is more appropriate for live migration, and live migration prediction may be performed later or even live migration prediction or live migration may not be performed for a virtual machine that ranks lower and that has a lower success rate of live migration. Therefore, as many virtual machines as possible can be successfully live-migrated while ensuring user experience and service quality, thereby improving resource utilization and reducing costs.

Step S103. Live-migrate the target virtual machine to the target physical node.

In an illustrated implementation, after the corresponding target physical node is determined for any target virtual machine in the at least one virtual machine to be migrated, the target virtual machine may be live-migrated from the source physical node in which the target virtual machine is located to the target physical node corresponding to the target virtual machine. Finally, the at least one virtual machine to be migrated is live-migrated to a respective corresponding target physical node.

In an illustrated implementation, after the target virtual machine is live-migrated from the source physical node in which the target virtual machine is located to the target physical node corresponding to the target virtual machine, services of the virtual machine may be restored on the target physical node.

In an illustrated implementation, during live migration of the target virtual machine, a live migration parameter of the target virtual machine may be further adjusted in real time based on the predicted live migration timeout probability of the target virtual machine. The live migration parameter may be used for controlling live migration duration of the target virtual machine, to minimize live migration timeout without affecting the running of other virtual machines.

In an illustrated implementation, the live migration parameter of the target virtual machine may include a data transmission rate limit corresponding to the target virtual machine during live migration. It should be noted that an objective of limiting a data transmission rate of a virtual machine is to prevent the virtual machine from occupying excessive network bandwidth during live migration, thereby affecting the normal running of another virtual machine or application.

FIG. 3 is a schematic structural diagram of a live migration system according to an exemplary embodiment. In an illustrated implementation, the live migration system 20 may include the server 200 shown in FIG. 1. Specifically, as shown in FIG. 3, the live migration system 20 may include a detection module 201, a performance profile module 202, a filtering module 203, a prediction module 204, a selection module 205, and a migration module 206. In an illustrated implementation, a communication connection may be established between the detection module 201, the performance profile module 202, the filtering module 203, the prediction module 204, the selection module 205, and the migration module 206 in a wired or wireless manner.

In an illustrated implementation, the detection module 201 is configured to: detect a status and performance of each physical node and a status and performance of each virtual machine running on the physical node in real time in a cloud computing environment, and transmit each piece of detected data to the performance profile module 202. The detection module 201 may be further configured to detect network traffic, resource usage, and the like of the physical nodes and the virtual machines. This is not specifically limited in this specification.

In an illustrated implementation, the performance profile module 202 is configured to: receive detection data about each virtual machine transmitted by the detection module 201, construct a performance profile of each virtual machine based on the detection data to obtain an instance performance profile of each virtual machine, and predict a live migration performance degradation rate of each virtual machine based on the instance performance profile of each virtual machine. In an implementation, the performance profile module 202 may further generate a performance degradation label and a migration eligibility label corresponding to each virtual machine based on the live migration performance degradation rate of each virtual machine. The performance degradation label may indicate a live migration performance degradation rate of the virtual machine, and the migration eligibility label may indicate that the virtual machine can be live-migrated. In an illustrated implementation, when the live migration performance degradation rate of a virtual machine is less than the performance degradation rate threshold, the virtual machine may have a corresponding migration eligibility label.

In an illustrated implementation, the filtering module 203 is configured to: receive the live migration performance degradation rate of each virtual machine transmitted by the performance profile module 202, and select at least one virtual machine to be migrated from a large number of virtual machines based on the live migration performance degradation rate of each virtual machine. For example, the filtering module 203 may select a virtual machine having a migration eligibility label (that is, a virtual machine whose live migration performance degradation rate is less than a performance degradation rate threshold) as the virtual machine to be migrated.

In an implementation, the filtering module 203 may be further configured to sort the selected at least one virtual machine to be migrated. In an illustrated implementation, the filtering module 203 may sort the at least one virtual machine to be migrated based on various factors such as a current resource occupation status and a subsequent resource occupation change of the virtual machine, a live migration performance degradation rate of the virtual machine, a user quota corresponding to the virtual machine, and total running duration of the virtual machine.

In an illustrated implementation, the prediction module 204 is configured to predict live migration results of virtual machines in the at least one virtual machine to be migrated sequentially according to an order obtained through the sorting, and transmit the predicted live migration result to the selection module 205.

In an illustrated implementation, the prediction module 204 may predict a live migration result of the virtual machine based on a prediction model obtained through pre-training. In an illustrated implementation, the live migration result may include a live migration timeout probability of the virtual machine.

In an illustrated implementation, the selection module 205 is configured to select an appropriate target physical node for the virtual machines sequentially according to an order obtained through the sorting based on the live migration results of the virtual machines predicted by the prediction module 204.

In an illustrated implementation, the migration module 206 is configured to: migrate each virtual machine to be migrated from a source physical node corresponding to the virtual machine to a corresponding target physical node, and restore services corresponding to the virtual machine on the target physical node. During live migration, the migration module 206 may further adjust a live migration parameter of each virtual machine in real time based on the live migration timeout probability of each virtual machine. This is not specifically limited in this specification.

For implementation processes of the functions and effects of the foregoing modules, refer to the descriptions in the embodiments corresponding to FIG. 1 and FIG. 2. Details are not described herein again.

In an illustrated implementation, the detection module 201, the performance profile module 202, the filtering module 203, the selection module 204, the prediction module 205, and the migration module 206 may be implemented by software, or may be implemented by hardware or a combination of software and hardware. This is not specifically limited in this specification. For example, the foregoing modules may be different servers, or may be different programs running in the same server, or the like. This is not specifically limited in this specification.

In summary, in a cloud computing system including a plurality of physical nodes, in the present application, status information of each virtual machine running on at least some of the plurality of physical nodes may be first obtained. Then, in the present application, at least one virtual machine that requires live migration may be determined from among all the virtual machines based on the status information of each virtual machine. For the virtual machine to be migrated, a live migration result of the virtual machine may be predicted first, and then an appropriate target physical node is selected for the virtual machine to be migrated based on the predicted live migration result, and is live-migrated to the target physical node. In this way, in the present application, a virtual machine that requires live migration is selected based on status information of the virtual machine, and an appropriate target physical node is further selected for the virtual machine based on a live migration prediction result of the virtual machine to perform live migration, to greatly improve the reliability of live migration and reduce risks such as a live migration failure and a live migration timeout, thereby ensuring the security and reliability of an entire cloud computing system, and providing a cloud service with higher quality and higher stability to a user.

Corresponding to the implementation of the foregoing method procedure, an embodiment of this specification further provides a live migration apparatus for a virtual machine. FIG. 4 is a schematic structural diagram of a live migration apparatus for a virtual machine according to an exemplary embodiment. The apparatus 30 may be applied to a cloud computing system. The cloud computing system may include a plurality of physical nodes, and a plurality of virtual machines run on at least some of the plurality of physical nodes. As shown in FIG. 4, the apparatus 30 includes:

a determining unit 301, configured to determine at least one virtual machine to be migrated from among the plurality of virtual machines based on status information of the plurality of virtual machines; a prediction unit 302, configured to: predict a live migration result for the at least one virtual machine to be migrated, and determine a target physical node corresponding to a target virtual machine from among the plurality of physical nodes based on the predicted live migration result, the target virtual machine being the virtual machine to be migrated; and a live migration unit 303, configured to live-migrate the target virtual machine to the target physical node.

In an illustrated implementation, the determining unit 301 is further configured to: predict a live migration performance degradation rate of each of the plurality of virtual machines based on the status information of the plurality of virtual machines, where the live migration performance degradation rate indicates a degree of performance loss incurred by the virtual machine during live migration; and determine a virtual machine whose live migration performance degradation rate is less than a performance degradation rate threshold in the plurality of virtual machines as the virtual machine to be migrated.

In an illustrated implementation, the prediction unit 302 is further configured to: predict a resource occupation status of the at least one virtual machine to be migrated based on a historical resource occupation status of the at least one virtual machine to be migrated; and

predict the live migration result for the at least one virtual machine to be migrated based on a current resource occupation status and a predicted resource occupation status of the at least one virtual machine to be migrated.

In an illustrated implementation, the prediction unit 302 is further configured to: sort the at least one virtual machine to be migrated based on a preset sorting reference factor; and sequentially predict live migration results of some virtual machines that rank high of the at least one virtual machine to be migrated according to a sequence obtained through the sorting.

In an illustrated implementation, the preset sorting reference factor includes one or more of the following factors, or a combination thereof: a current resource occupation status and a predicted resource occupation status of the virtual machine, sensitivity of the virtual machine to a running environment change, a live migration performance degradation rate of the virtual machine, a user performance degradation preference corresponding to the virtual machine, a user quota corresponding to the virtual machine, and a total running duration of the virtual machine.

In an illustrated implementation, the predicted live migration result includes a live migration timeout probability, where the live migration timeout probability indicates a probability that live migration duration required by the virtual machine during live migration exceeds a duration threshold.

In an illustrated implementation, the live migration unit 303 is further configured to adjust a live migration parameter of the target virtual machine based on a predicted live migration timeout probability of the target virtual machine in a process of live-migrating the target virtual machine to the target physical node, where the live migration parameter is used for controlling live migration duration of the target virtual machine.

In an illustrated implementation, the live migration parameter of the target virtual machine includes a data transmission rate limit corresponding to the target virtual machine during live migration.

In an illustrated implementation, the prediction unit 302 is further configured to predict the live migration result for the at least one virtual machine to be migrated based on a prediction model obtained through pre-training, where the prediction model is an ensemble model that is obtained through training based on an ensemble learning algorithm and in which at least two machine learning models used for predicting a live migration result are ensembled.

In an illustrated implementation, the status information includes one or more of the following data, or a combination thereof: CPU usage, memory usage, disk usage, network bandwidth, network latency, and throughput of the virtual machine.

For an implementation process of the functions and effects of the units in the apparatus 30, refer to the descriptions in the embodiments corresponding to FIG. 1 to FIG. 3 for details. Details are not described herein again. It should be understood that the foregoing apparatus 30 may be implemented by software, or may be implemented by hardware or a combination of software and hardware. A software implementation is used as an example. An apparatus in a logical sense is formed by reading corresponding computer program instructions into memory by using a processor (CPU) of a device in which the apparatus is located. From the perspective of hardware, in addition to a CPU and a memory, a device in which the foregoing apparatus is located generally further includes other hardware such as a chip configured to receive and transmit a radio signal and/or other hardware such as a card configured to implement a network communication function.

The apparatus embodiments described above are merely examples. The units described as separate parts may or may not be physically separate, and parts displayed as units may or may not be physical modules, and may be located at one position, or may be distributed on a plurality of network modules. Some or all of the units or modules may be selected depending on actual requirements to achieve the objectives of the solutions in this specification. Persons of ordinary skill in the art can understand and implement the solutions without creative efforts.

The apparatuses, units, and modules described in the above embodiments may be specifically implemented by a computer chip or entity, or by a product with some functionality. An exemplary implementation device is a computer. A specific form of the computer may be a personal computer, a laptop computer, a cellular phone, a camera phone, a smart phone, a personal digital assistant, a media player, a navigation device, an email receiving and sending device, a gaming console, a tablet computer, a wearable device, or a combination of any several devices in these devices.

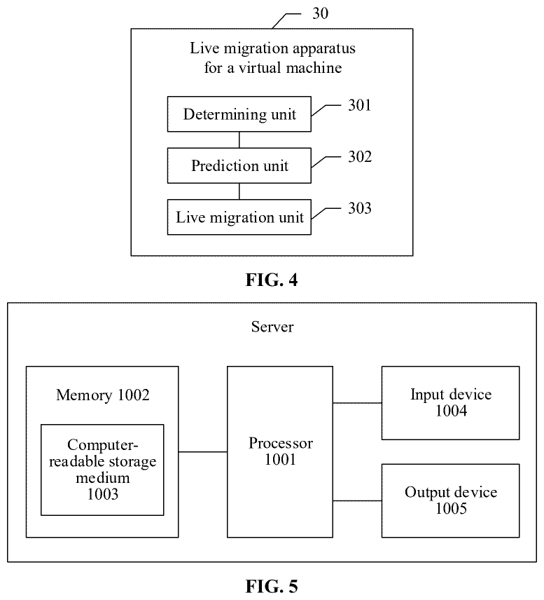

Corresponding to the foregoing method embodiments, an embodiment of this specification further provides a server. FIG. 5 is a schematic structural diagram of a server according to an exemplary embodiment. For example, the server may be the server 200 shown in FIG. 1. For example, the server 200 may be any one of the physical node 100a, the physical node 100b, the physical node 100c, and the like in the cloud computing system shown in FIG. 1. Alternatively, the server 200 may be any other possible server, server cluster, or the like configured to perform the foregoing live migration method for a virtual machine in the cloud computing system. This is not specifically limited in this specification. As shown in FIG. 5, the server may include a processor 1001 and a memory 1002, and may further include an input device 1004 (for example, a keyboard) and an output device 1005 (for example, a display). The processor 1001, the memory 1002, the input device 1004, and the output device 1005 may be connected by a bus or in another manner. As shown in FIG. 5, the memory 1002 includes a computer-readable storage medium 1003. The computer-readable storage medium 1003 stores a computer program that can be executed by the processor 1001. The processor 1001 may be a general purpose processor, a microprocessor, or an integrated circuit configured to control the execution of the foregoing method embodiments. When executing the stored computer program, the processor 1001 may perform the steps of the live migration method for a virtual machine in the embodiments of this specification, including: obtaining status information of a plurality of virtual machines, and determining at least one virtual machine to be migrated from among the plurality of virtual machines based on the status information; predicting a live migration result for the at least one virtual machine to be migrated, and determining a target physical node corresponding to any target virtual machine in the at least one virtual machine to be migrated from among a plurality of physical nodes based on the predicted live migration result; and live-migrating the target virtual machine to the target physical node, and the like.

For detailed descriptions of steps of the foregoing live migration method for a virtual machine, refer to the foregoing content, and details are not described herein again.

In summary, in a cloud computing system including a plurality of physical nodes, in the present application, status information of each virtual machine running on at least some of the plurality of physical nodes may be first obtained. Then, in the present application, at least one virtual machine that requires live migration may be determined from among all the virtual machines based on the status information of each virtual machine. For the virtual machine to be migrated, a live migration result of the virtual machine may be predicted first, and then an appropriate target physical node is selected for the virtual machine to be migrated based on the predicted live migration result, and is live-migrated to the target physical node. In this way, in the present application, a virtual machine that requires live migration is selected based on status information of the virtual machine, and an appropriate target physical node is further selected for the virtual machine based on a live migration prediction result of the virtual machine to perform live migration, to greatly improve the reliability of live migration and reduce risks such as a live migration failure and a live migration timeout, thereby ensuring the security and reliability of an entire cloud computing system, and providing a cloud service with higher quality and higher stability to a user.

Corresponding to the foregoing method embodiments, an embodiment of this specification further provides a computer-readable storage medium. The storage medium has computer programs stored therein. When the computer programs are executed by a processor, the steps of the live migration method for a virtual machine in the embodiments of this specification are performed. For details, refer to the descriptions of the embodiments corresponding to FIG. 1 to FIG. 3, and details are not described herein again.

Described above are merely exemplary embodiments of this specification, and are not intended to limit this specification. Within the spirit and principles of this specification, any modifications, equivalent replacements, improvements, and the like shall fall within the scope of the protection of this specification.

In a typical configuration, the terminal device includes one or more processors (CPUs), an input/output interface, a network interface, and memory.

The memory may include a form such as a non-permanent memory, a random access memory (RAM) and/or a non-volatile memory such as a read-only memory (ROM) or a flash memory (flash RAM) in a computer-readable medium. The memory is an example of a computer-readable medium.

Computer-readable media include permanent and non-permanent, removable and non-removable media, and can implement storage of information by using any method or technology. The information may be computer-readable instructions, data structures, modules of a program, or other data.

An example of the storage medium of the computer includes, but is not limited to, a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another storage technology, a compact disc read-only memory (CD-ROM), a digital versatile disc (DVD) or another optical storage, a cassette tape, a tape disk storage or another magnetic storage device or any another non-transmission medium, and may be configured to store information accessible by a computing device. According to the definitions herein, the computer-readable medium does not include a transitory computer-readable medium (transitory media), for example, a modulated data signal and carrier.

It should be further noted that the terms “include”, “comprise”, or any variation thereof are intended to cover a non-exclusive inclusion. Therefore, in the context of a process, a method, a commodity, or a device that includes a series of elements, the process, method, object or device not only includes such elements, but also includes other elements not specified expressly, or may include inherent elements of the process, method, commodity, or device. If no more limitations are made, an element limited by “include a/an . . . ” does not exclude other same elements existing in the process, the method, the commodity, or the device which includes the element.

Persons skilled in the art should understand that the embodiments of this specification may be provided as a method, a system, or a computer program product. Therefore, the embodiments of this specification may use a form of hardware only embodiments, software only embodiments, or embodiments with a combination of software and hardware. Moreover, the embodiments of this specification may use a form of a computer program product that is implemented on one or more computer-usable storage media (including but not limited to a disk memory, a CD-ROM, an optical memory, and the like) that include computer usable program code.

1. A live migration method for a virtual machine, applied to a cloud computing system, wherein the cloud computing system comprises a plurality of physical nodes, and a plurality of virtual machines are run on at least some of the plurality of physical nodes; the method comprising:
determining at least one virtual machine to be migrated from among the plurality of virtual machines based on status information of each of the plurality of virtual machines;
predicting a live migration result for each of the at least one virtual machine to be migrated, and determining a target physical node corresponding to a target virtual machine from among the plurality of physical nodes based on the predicted live migration result, the target virtual machine being the virtual machine to be migrated; and
live-migrating the target virtual machine to the target physical node.

2. The method according to claim 1, wherein the determining the at least one virtual machine to be migrated from among the plurality of virtual machines based on the status information of each of the plurality of virtual machines comprises:
predicting a live migration performance degradation rate of each of the plurality of virtual machines based on the status information of each of the plurality of virtual machines, wherein the live migration performance degradation rate indicates a degree of performance loss of the virtual machine caused by live migration; and
determining a virtual machine whose live migration performance degradation rate is less than a performance degradation rate threshold in the plurality of virtual machines as the virtual machine to be migrated.

3. The method according to claim 2, wherein the predicting the live migration result for each of the at least one virtual machine to be migrated comprises:
predicting a resource occupation status of the virtual machine to be migrated based on a historical resource occupation status of the virtual machine to be migrated; and
predicting the live migration result for the virtual machine to be migrated based on a current resource occupation status and the predicted resource occupation status of the virtual machine to be migrated.

4. The method according to claim 3, wherein the predicting the live migration result for each of the at least one virtual machine to be migrated comprises:
sorting the at least one virtual machine to be migrated based on a preset sorting reference factor; and
sequentially predicting live migration results of some virtual machines that rank high of the at least one virtual machine to be migrated according to a sorted sequence.

5. The method according to claim 4, wherein the preset sorting reference factor comprises a combination of one or more factors:
the current resource occupation status and the predicted resource occupation status of the virtual machine, sensitivity of the virtual machine to a running environment change, the live migration performance degradation rate of the virtual machine, a user performance degradation preference corresponding to the virtual machine, a user quota corresponding to the virtual machine, and total running duration of the virtual machine.

6. The method according to claim 1, wherein the predicted live migration result comprises a live migration timeout probability, wherein the live migration timeout probability indicates a probability that live migration duration required by the virtual machine during live migration exceeds a duration threshold.

7. The method according to claim 6, wherein the live-migrating the target virtual machine to the target physical node comprises:
adjusting a live migration parameter of the target virtual machine based on a predicted live migration timeout probability of the target virtual machine in a process of live-migrating the target virtual machine to the target physical node, wherein the live migration parameter is used for controlling live migration duration of the target virtual machine.

8. The method according to claim 1, wherein the predicting the live migration result for each of the at least one virtual machine to be migrated comprises:
predicting the live migration result for the virtual machine to be migrated based on a prediction model obtained through pre-training, wherein the prediction model is an ensemble model that is obtained through training based on an ensemble learning algorithm and in which at least two machine learning models used for predicting the live migration result are integrated.

9. The method according to any one of claims 1 to 8, wherein the status information comprises a combination of one or more data:
CPU usage, memory usage, disk usage, network bandwidth, network latency, and throughput of the virtual machine.

10. A live migration apparatus for a virtual machine, applied to a cloud computing system, wherein the cloud computing system comprises a plurality of physical nodes, and a plurality of virtual machines are run on at least some of the plurality of physical nodes; the apparatus comprising:
a determining unit, configured to determine at least one virtual machine to be migrated from among the plurality of virtual machines based on status information of each of the plurality of virtual machines;
a prediction unit, configured to: predict a live migration result for each of the at least one virtual machine to be migrated, and determine a target physical node corresponding to a target virtual machine from among the plurality of physical nodes based on the predicted live migration result, the target virtual machine being the virtual machine to be migrated; and
a live migration unit, configured to live-migrate the target virtual machine to the target physical node.

11. A computing device, comprising a memory and a processor, the memory having a computer program executable on the processor stored therein; the processor, when executing the computer program, performing the method according to any one of claims 1 to 10.

12. A computer-readable storage medium, having a computer program stored therein, and the computer program, when executed by a processor, implementing the method according to any one of claims 1 to 10.
